(19) United States
(12) Patent Application Publication
(10) Pub. No.: US 2019/0069509 A1
(43) Pub. Date: Mar. 7, 2019

(54) Stretchable Pet Crate Cover

(71) Applicants: Elaine Gulati, Fort Myers, FL (US); Nicole Gulati, Fort Myers, FL (US); Nina Gulati, Fort Myers, FL (US)

(72) Inventors: Elaine Gulati, Fort Myers, FL (US); Nicole Gulati, Fort Myers, FL (US); Nina Gulati, Fort Myers, FL (US)

(21) Appl. No.: 16/120,669

(22) Filed: Sep. 4, 2018

Related U.S. Application Data
(60) Provisional application No. 62/553,504, filed on Sep. 1, 2017.

(51) Int. Cl. A01K 1/02

(52) U.S. Cl. CPC A01K 1/0245

(57) ABSTRACT

A pet crate cover includes a resiliently stretchable sleeve having front and back ends. The sleeve is stretched to expand a ventilation opening formed in one end of the sleeve and a pet crate is inserted into the sleeve through the expanded ventilation opening. The resilient material of the sleeve constrains the sleeve to snugly interengage the covered pet crate and air flow to the interior of the crate is provided through the ventilation opening.

### RELATED APPLICATION

This application claims the benefit of provisional application Ser. No. 62/553,504 filed Sep. 1, 2017.

### FIELD OF THE INVENTION

This invention relates to decorative, form fitting fabric cover for a pet crate and, more particularly, to a pet crate cover that includes front and rear openings that ventilate the interior of the pet crate.

### BACKGROUND OF THE INVENTION

Dogs, cats, birds and other household pets may occasionally have to be confined to a cage or crate. This may occur, for example, if the pet is being transported, is recuperating from an injury or illness, is not housebroken or at various other times when confinement is required.

In some situations, it may be desirable to cover the pet enclosure such as when the confined pet needs to go to sleep and/or is overly excited by surrounding activity. A wide variety of conventional crate covers are currently available. However, these products tend to be bulky, cumbersome and relatively unattractive. Most fit the enclosure rather poorly and are suited for use on only a narrow selection of crates and cages having compatible sizes. No known universal pet crate covers are presently available, which fit most sizes and shapes of pet crates.

Many pet crate covers also do not allow for the interior of the crate or cage to be properly ventilated. A number of conventional products employ retractable flaps or sides. Not only do these sides have to be secured in an open condition so that the crated pet can breathe properly, they do not allow air to flow freely through the crate or cage.

### SUMMARY OF THE INVENTION

It is therefore an object of the present invention to provide an improved cover for pet crates and cages, which is much more aesthetically attractive than existing covers.

It is a further object of this invention to provide a pet crate cover that employs a stretchable, form fitting fabric to provide the covered pet crate with a sleek and attractive appearance.

It is a further object of this invention to provide a universal pet crate cover that is resiliently stretchable so that it fits virtually all sizes and shapes of pet crates and cages.

It is a further object of this invention to provide a pet crate cover featuring front and back ventilation openings that allow fresh air to flow freely through the cage in a cross ventilated manner so that the enclosed pet is able to breathe comfortably within the covered enclosure.

It is a further object of this invention to provide a pet crate cover featuring a simple, easy to assemble and relatively inexpensive construction.

It is a further object of this invention to provide a pet crate cover that may carry a virtually unlimited variety of attractive and whimsical designs, which contribute to the attractiveness of the cover.

It is a further object of this invention to provide a pet crate cover that enables a pet crate to present a much more attractive design appearance within the pet owner's home and which reduces the need for removing the crate when visitors are at the home.

This invention features a pet crate cover that includes a resiliently stretchable sleeve having opposing front and back ends. At least one of the front and back ends includes a ventilation opening formed therein and communicating with an interior of the sleeve. The sleeve is stretched to resiliently expand the interior of the sleeve and widen a ventilation opening at one end such that a pet crate is insertible through the widened opening and into the expanded sleeve. The stretched sleeve is then allowed to relax and contract such that it peripherally grips the pet crate with each ventilation opening disposed across a corresponding vertical side or grate of the crate.

In a preferred embodiment, the sleeve is longer front end to back end than the pet crate is from front grate to back grate. The front and back openings may be peripherally surrounded by corresponding edges of the sleeve that carry respective elastic elements. The elastic elements constrain the front and back openings of the sleeve such that when a pet crate is inserted into the cover, the front and back ends of the stretchable sleeve overlap the front and back grates of the inserted pet crate respectively. This provides for a snug and substantially flush interengagement between the front and back ends of the sleeve and the crate. The elastic element may extend through a respective seam or channel formed in the sleeve about the edge of a respective opening. Alternatively, the elastic element may comprise a gathered or pleated integral portion of the sleeve.

The stretchable sleeve may include a single sheet of resilient fabric that is stitched or sewn to itself along respective opposing edges of the sheet. A wide variety of resilient stretchable materials may be employed to form the resiliently stretchable sheet. These may include assorted natural and synthetic materials. The outer surface of the sheet may carry various ornamental designs.

In alternative embodiments, the sleeve may be formed by interconnecting the opposing edges of the sheet by various other means such as Velcro™, buttons, snap fasteners and/or zippers.

### BRIEF DESCRIPTION OF THE DRAWINGS

Other objects, features and advantages will occur from the following description of a preferred embodiment and the accompanying, drawings, in which:

FIG. 1 is a front perspective and partly cut away view of a stretchable pet crate cover according to this invention as attached to a wire pet crate;

FIG. 2 is a plan view of a resiliently stretchable sheet used to form the cover of this invention;

FIG. 3 is a plan view of the sheet with elastic seams formed along opposing front and back edges of the sheet;

FIG. 4 is a perspective view of the tubular sleeve formed by interconnecting opposing ends of the stretchable sheet;

FIG. 5 is a front perspective view of the assembled cover enclosing a wire frame pet crate with the front door of the crate exposed through the front opening in the assembled sleeve,

FIG. 6 is a perspective view of an alternative version of the pet crate cover with a closed back end; and

FIG. 7 is a perspective view of the pet crate cover of FIG. 6 attached to a wire pet crate.

### DETAILED DESCRIPTION OF PREFERRED EMBODIMENTS

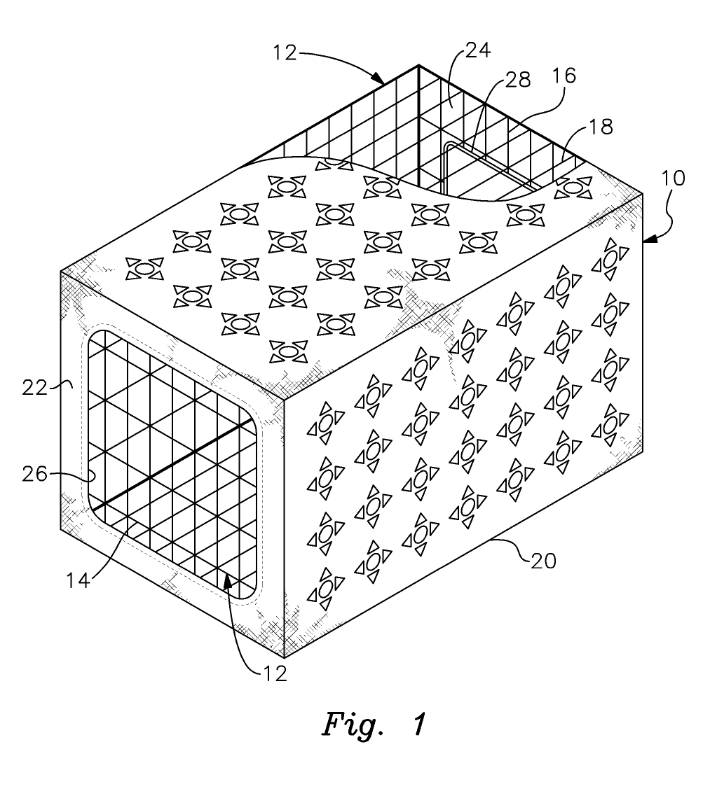

There is shown in FIG. 1 a stretchable pet crate cover 10 operably engaged with and enclosing a standard pet crate 12. The crate includes a standard wire cage construction having a generally six-sided rectangular or parallelepiped configuration. As used herein “pet crate” should be understood to include all types, sizes and shapes of portable cages and crates and other enclosures for containing household pets and other animals. A portion of cover 10 is cut away in FIG. 1 to better depict the crate 12. In particular, the crate has a vertical front side or grate 14 and an opposite vertical rearward grate 16 which are interconnected by a horizontal top grate 18. The crate also features vertical left hand and right hand side grates (which are obscured by cover 10) and a horizontal bottom grate or base, which is not shown. It should be understood by persons skilled in the art that the base typically holds a tray on which the dog, cat or other pet is supported. Each of the grates, as well as the base of the crate, comprise a standard wire frame construction although alternative constructions may be used. At least front grate 14 typically includes a door that is hingedly attached to the front grate in a conventional manner. The rearward grate (and/or either side grate) may also include such a door. As used herein, the term “grate” should be understood to encompass various types of walls or sides of the crate.

Pet crate 12 may have various sizes and shapes in accordance with this invention. The particular size, shape or dimensions of the crate do not constitute limitations of the invention. Moreover, it should be readily understood that crate 12 may be used to accommodate virtually any type of household pet including, but not limited to dogs, cats, birds, rodents, small mammals, reptiles, etc.

Cover 10 includes a resiliently stretchable material that is wrapped about and snugly grips underlying crate 12. Cover 10 effectively comprises a sleeve 20 that surrounds and engages top grate 18 of crate 12, as well as the obscured side grates and base of the crate. Sleeve 20 has front and back ends 22 and 24, respectively, that are constructed and configured as described more fully below. A front ventilation opening 26 is formed in front end 22 and a similar rear ventilation opening 28 is likewise formed in back end 24. The ventilation openings 26 and 28 align respectively with the front and back grates 14 and 16 of crate 12 to provide for free flowing cross-ventilation through the interior of crate 12 as described more fully below.

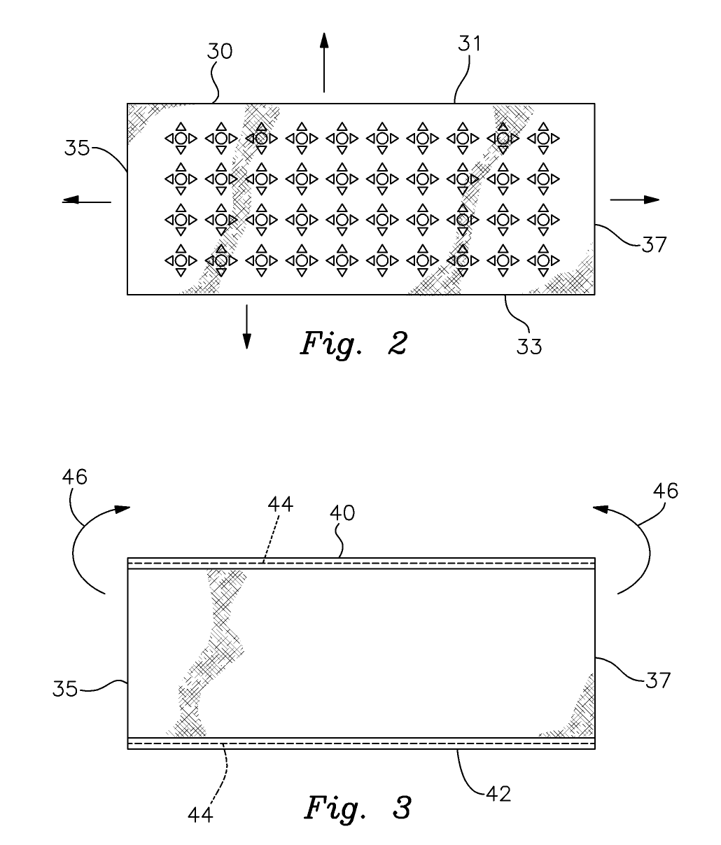

Cover 10 is constructed and assembled in the manner shown in FIGS. 2-4. In particular, as shown in FIG. 2, the stretchable pet crate cover includes a single sheet 30 comprising a resiliently expandable material. This sheet may comprise, but is not limited to the following materials: cotton, cotton weave mat, polyester, bonded leather, faux leather, canvas, velvet, acrylic, nylon, microfiber mat, fleece, wicker mat, mesh fabric, sea grass mat, Sunbrella™ fabric, Coolaroo™ fabric, velour, silk, nylon elastomer, weatherproof material, foam rubber, polyvinyl chloride, closed cell resistant foam, plastic, polypropylene, polyurethane, polyethylene and various combinations or composites of such materials. A blend of spandex, elastane or Lycra™, and polyester is especially preferred. In any event, the material should be stretchable or resiliently expandable so that it provides a sleek, form-fitting interengagement with the enclosed pet crate. Sheet 30 has front and back edges 31 and 33 that are interconnected by left hand and right hand ends 35 and 37.

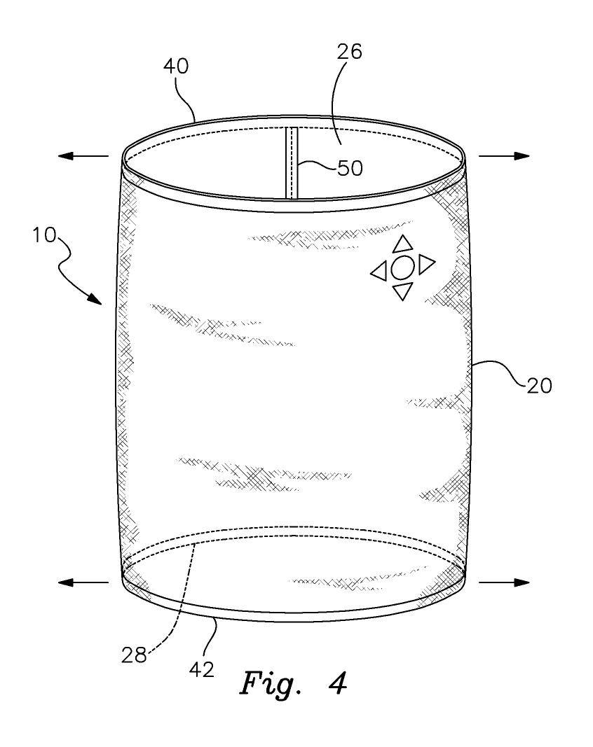

As shown in FIG. 3, a pair of seams 40 and 42 are formed respectively in the front and rear edges of sheet 30. Each seam may accommodate respective elongate elastic element 44 that extends through the seam and has a unstretched length that is less than the length of the seam. The seamed edges may alternatively be gathered, pleated or otherwise constructed to define an elastic seam along each edge (i.e. the elastics may be formed integrally with seams 40 and 42). Ends 35 and 37 are turned toward one another as indicated by arrows 46 in FIG. 3. These ends are then interengaged and stitched or sewn together, as shown in FIG. 4, along a seam 50. This forms sleeve 20 having resiliently expandable seams 40 and 42 formed respectively along the front and back edges of the sleeve. Front opening 26 is formed through forward seam 40 and back opening 28 is similarly formed through rearward seam 42. When cover 10 is engaged with crate 12 elastic elements 44 constrain openings 26 and 28 and stretchable sleeve 20 such that the front and back ends 22 and 24 of the cover 10 overlap front and back grates 14 and 16 of crate 12. This enables the cover to snugly and securely interengage and fit onto create 12 as shown in FIG. 1.

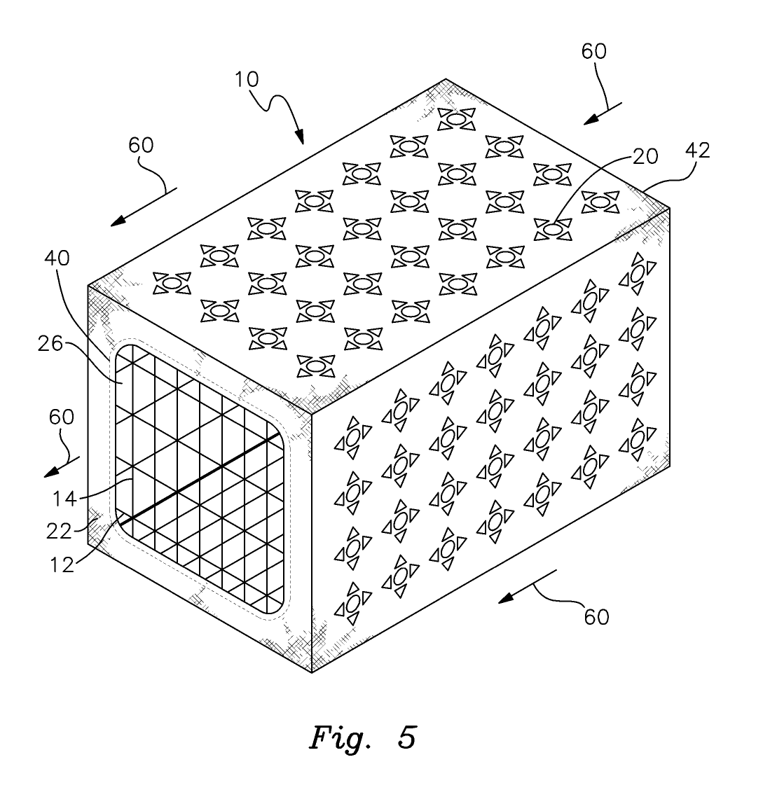

Cover 10 is depicted in its fully constructed state in FIG. 4. To install the cover over a pet crate 12, the user simply stretches one of the resilient edges/seams 40, 42 to expand its respective opening 26, 28. Cover 10 is then pulled over and onto the pet crate 12. For example, as shown in FIG. 5, resilient leading edge 40 surrounding front opening 26 is stretched open so that cover 10 may be slid onto the crate as indicated by arrows 60. Resilient leading edge seam 40 of cover 10 is pulled beyond the front door and grate 14 of crate 12, and released. As a result, front end 22 of sleeve 20 resiliently contracts, overlaps and snugly engages the periphery of front grate 14 of crate 12. Because of the elastic nature of leading edge seam 40, the contracted forward end 22 of sleeve 20 is narrower than the remainder of sleeve 20, which is stretched and expanded by the crate. This causes the leading end of the cover to snugly overlap and grip the front grate 14 of the pet crate. By the same token, the trailing edge 42 of cover 20 includes a resilient elastic construction, as described above, which allows the back end 24 of the cover to snugly interengage the back grate of the crate in a similar manner. This is best depicted in FIG. wherein rearward end 24 of cover 10 overlaps and snugly interengages back grate 16 of crate 12. Cover 10 thereby snugly and conformably grips the periphery of crate 12 in the manner shown such that openings are formed over grates 14 and 16 and the remaining top, bottom and side grates are fully covered.

With cover 10 snugly and securely interengaged about crate 12, front and back openings 26 and 28 are respectively aligned with the front and back grates 14 and 16 of the pet crate. The aligned openings thereby provide effective cross-ventilation and necessary air flow through the pet crate. This allows the confined pet to breathe easily and freely, even when the cover is attached to the crate.

In alternative embodiments of this invention, one end of the sleeve may be closed such that the cover has a sock-like configuration. For example, one of the open ends 26, 28 described above may be stitched/micro stitched or the cover may be otherwise manufactured such that the stretchable sleeve includes one closed stretchable end. In such cases the single elastic opening is expanded to insert the pet crate therethrough and install the cover onto the crate. The installed cover essentially appears as shown in FIG. 5, wherein only a single ventilation opening 26 is shown.

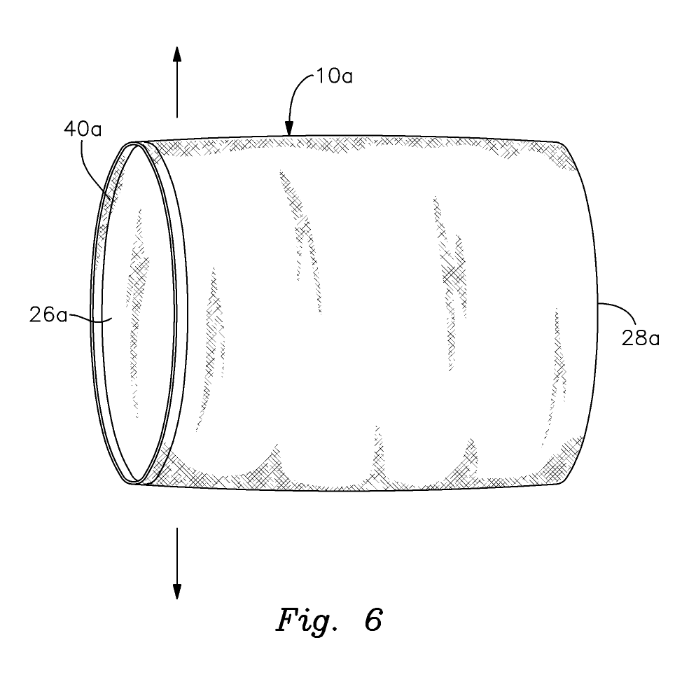

FIG. 6 illustrates the alternative version of the pet crate cover of this invention, which includes an open end 26a and an opposite closed end 28a. Various known means of assembling cover 10a may be employed in the scope of this invention. Cover 10a may include materials identical or analogous to those employed in the previously described embodiment. Front opening 26a is surrounded by a stretchable elastic seam 40a. Again, the construction of the seam, as well as the remainder of cover 10a is analogous to the manner of construction described for the prior embodiment.

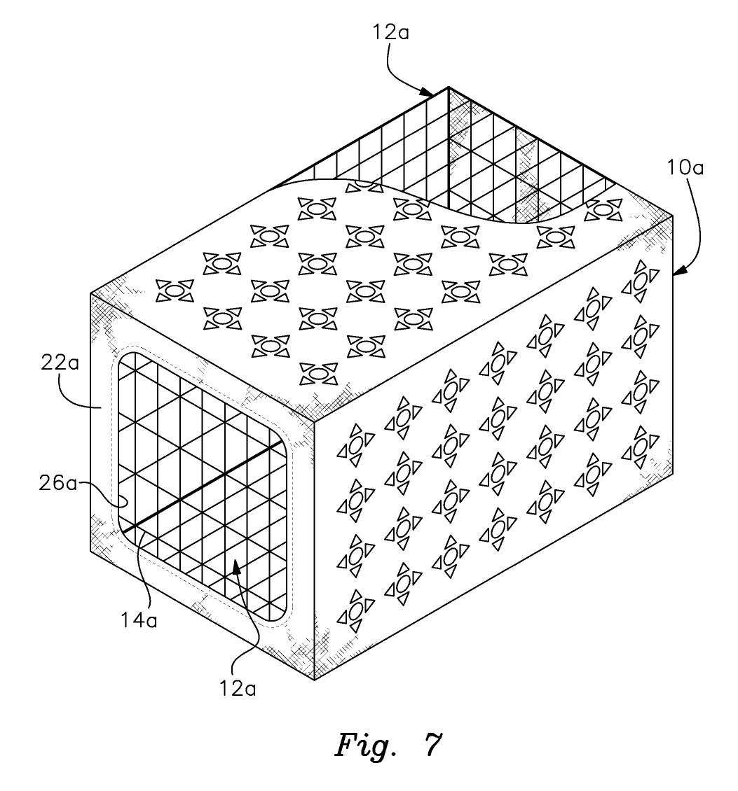

Cover 10a is depicted in its fully constructed state in FIG. 6. To install the cover over a pet crate 12a, shown in FIG. 7, the user simply stretches resilient seam 40a to expand opening 26a. Cover 10 is then pulled over and onto pet crate 12a. For example, the resilient seam 40a, FIG. 6, surrounding front opening 26a may be stretched open so that crate 12a may be inserted into or received by the cover through expanded opening 26a. After the crate is fully inserted into cover 10a, the widened or expanded opening 26a is released and, as best shown in FIG. 7, front end 22a of cover 10a resiliently contracts and snugly engages the periphery of front wall or grate 14a of crate 12a. Because of the elastic nature of the leading edge seam 40a, the contracted forward end 22a of cover 10a is narrower than then remainder of the engaged cover, which is itself stretched and expanded by the crate. This causes the leading end of cover 10a to snugly overlap and grip the front grate 14a of pet crate 12a. By the same token, back end 24a expands to fully cover the back side or grate 16a of crate 12a. As in the prior embodiment, cover 10a snugly and conformably engages each grate of crate 12a. In the version of FIG. 7 only a single ventilation opening is provided and the crate is otherwise fully enclosed by cover 10a.

As shown in FIGS. 1 and 5, cover 10 may include a virtually unlimited variety of aesthetically attractive and whimsical aesthetic designs that may be printed on or otherwise applied to the cover. Various forms of advertising may also be applied to the exterior surface of the cover.

Pet cover 10 provides for a number of benefits that represent significant improvements over the prior art. Significantly, the cover employs a resiliently stretchable fabric construction that is both relatively simple and inexpensive to manufacture. The stretchable fabric also enables the cover to fit pet crates having virtually any size and shape in a snug, secure, sleek and aesthetically attractive manner. The stretchable fabric easily and reliably expands so that it attractively conforms to most if not all pet crate brands and models. The pet crate cover thereby provides essentially “universal” coverage for virtually all makes and models of pet crates and cages. The product may be installed by almost anyone quickly and conveniently on the pet carrier. It does not require the use of complicated assembly, instructions, retractable flaps, windows, latches or other mechanisms. The size of the sleeve and the length of the elastic seams formed about the openings may be simply varied in size to accommodate pet crates that are significantly larger or smaller than standard sized crates.

The aligned front and back ventilation openings automatically enable the free flow of air through the interior of the enclosed pet crate. Even the versions featuring a single ventilation opening provide for beneficial interior ventilation of the crate. The confined pet is therefore able to breathe comfortably within the crate with the pet cover attached. The closed back end/single ventilation opening version may be employed in situations where ventilation is not as great a concern and/or where less visual stimulation or greater privacy are desired for the pet.

Combined with the snug and sleek universal design, the variety of ornamental designs that may be used with the cover provide for a much more attractive pet cover appearance. As a result, the covered crate or cage may be used and displayed much more attractively in the pet owner's home. It is less likely that the crate will have to be moved when guests or visitors are present.

Accordingly, the present invention relates to a simpler, less expensive and more universal pet crate cover which provides for improved ventilation of the crate and a much more attractive appearance than is achieved by existing products. While this detailed description has set forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not (imitative thereof.

Although specific features of the invention are shown in some of the drawings and not others, this is for convenience only, as each feature may be combined with any and all of the other features in accordance with this invention.

What is claimed is:

1. A pet crate cover comprising:
a resiliently stretchable sleeve having a ventilation opening formed therethrough in communication with an interior of said sleeve; said sleeve being stretched to widen said ventilation opening and expand said interior of said sleeve for introducing a pet crate into said interior of said sleeve through said ventilation opening; said sleeve being allowed to contract against the pet crate such that said sleeve snugly and conformably grips a periphery of the pet crate and said ventilation opening extends across a corresponding side of the pet crate.

2. The cover of claim 1 in which said sleeve includes opposing front and back ends for respectively engaging respective sides of a pet crate received by the sleeve when the cover is in a contracted condition.

3. The cover of claim 2 in which said ventilation opening is formed in said front end of said sleeve.

4. The cover of claim 1 in which said ventilation opening is peripherally surrounded by a corresponding edge of said sleeve that carries an elastic element, which constrains the ventilation opening of said sleeve such that when a pet crate is introduced into said sleeve and this sleeve is allowed to contract, the stretchable sleeve overlaps and engages the corresponding side of the pet crate across which said ventilation opening extends.

5. The cover of claim 4 in which said elastic element extends through a seam formed in said sleeve about an edge of said ventilation opening.

6. The cover of claim 5 in which said elastic element includes a pleated integral portion of said sleeve.

7. The cover of claim 3 in which a second ventilation opening is formed in said back end of said sleeve, which second ventilation opening being disposed across a second corresponding side of the pet crate when said sleeve is allowed to contract against a pet crate introduced into said interior of said sleeve.

8. The cover of claim 7 in which said second ventilation opening is peripherally surrounded by a corresponding second edge of said sleeve that carries a respective second elastic element, said second elastic element constraining said second ventilation opening of said sleeve such that when a pet crate is introduced into said sleeve, said back end of said stretchable sleeve overlaps the back sides of the pet crate to provide a snug and substantially conformable interengagement between said back end of said sleeve and the back side of the crate.

9. The cover of claim 8 in which said second elastic element extends through a second seam formed in said sleeve about the second edge of said second ventilation opening.

10. The cover of claim 8 in which said second elastic element includes a pleated integral portion of said sleeve.

11. The cover of claim 1 in which said stretchable sleeve includes a single sheet of resilient fabric that is stitched or sewn to itself along respective opposing edges of said sheet.

12. A covered pet crate assembly comprising:
a pet crate having a plurality of sides that enclose an interior of said pet crate;
a resiliently stretchable sleeve having a ventilation opening formed therethrough in communication with an interior of said sleeve; said sleeve being stretched to widen said ventilation opening and expand said interior of said sleeve for introducing a pet crate into said interior of said sleeve through said ventilation opening; said sleeve being allowed to contract against said pet crate such that said sleeve snugly and conformably grips a periphery of the pet crate with said ventilation opening disposed across a corresponding side of the pet crate.

13. The cover of claim 12 in which said sides of said pet crate include respective wire grates.

14. A crate cover comprising:
a resiliently stretchable sleeve having opposing front and back ends;
a first ventilation opening formed through said first end of said sleeve in communication with an interior of said sleeve;
a pair of ventilation openings respectively formed through said front and back ends of said sleeve in communication with an interior of said sleeve; said sleeve being stretched to widen at least one of said ventilation openings and expand said interior of said sleeve for introducing a pet crate into said interior of said sleeve through one of said ventilation openings; said sleeve being allowed to contract against the pet crate such that said sleeve snugly and conformably grips a periphery of the pet crate with said ventilation openings disposed across corresponding vertical sides of the pet crate.

15. The cover of claim 14 in which each said ventilation opening is peripherally surrounded by a corresponding edge of said sleeve, each corresponding edge carrying a respective elastic element that constrains said ventilation opening such that when a pet crate is introduced into said sleeve and said sleeve is allowed to contract, said stretchable sleeve overlaps and snugly engages the corresponding side to the pet crate across which said ventilation opening extends.
